(19) United States
(12) Patent Application Publication
(10) Pub. No.: US 2024/0274840 A1
(43) Pub. Date: Aug. 15, 2024

(54) FUEL CELL HAVING ELASTOMER LAYERS AND METHOD FOR PRODUCING A FUEL CELL

(71) Applicant: AUDI AG, Ingolstadt (DE)

(72) Inventors: Martin GÖBEL, Heilbronn (DE); Oliver KEITSCH, Heilbronn (DE); Daniela KÖNNICKE, Neudenau (DE); Nico RIEDE, Stuttgart (DE); Raimund Theo STRÖBEL, Heilbronn (DE)

(21) Appl. No.: 18/561,577

(22) PCT Filed: May 25, 2022
(86) PCT No.: PCT/EP2022/064149

§ 371 Date: Nov. 16, 2023

(30) Foreign Application Priority Data
May 31, 2021 (DE) 10 2021 113 960.0

(51) Int. Cl. H01M 8/0273; H01M 8/0284; H01M 8/0286

(52) U.S. Cl. CPC H01M 8/0273; H01M 8/0284; H01M 8/0286

(57) ABSTRACT

The disclosure relates to a fuel cell having a membrane electrode assembly installed in a cutout of a frame, a first bipolar plate arranged on a first side of the membrane electrode assembly and a second bipolar plate arranged on a second side of the membrane electrode assembly, the second side being opposite the first side. An edge region of the frame comprises a first elastomer layer on a first side of the edge region of the frame, the first side facing toward the first bipolar plate. The edge region of the frame further comprises a second elastomer layer on a second side of the edge region of the frame, the second side facing toward the second bipolar plate. The first and second elastomer layers are each formed as a film. The first and second elastomer layers are configured to fluidly seal the bipolar plates. A method for producing a fuel cell is also provided.

### BACKGROUND

### Technical Field

Embodiments of the invention relate to a fuel cell having a membrane electrode assembly. Embodiments of the invention furthermore relate to a method for producing a fuel cell.

### Description of the Related Art

Fuel cells, such as those used in the context of a fuel cell system for the operation of motor vehicles, comprise a membrane electrode assembly, formed from a proton conducting membrane, on one side of which the anode is formed and on the other side the cathode, wherein the electrodes are cast or sprayed onto the membrane or hot pressed by means of a calendaring process in order to achieve an intimate contact. Reactant gases are supplied to the electrodes, namely, hydrogen at the anode side and oxygen or a gas containing oxygen, especially air, at the cathode side. In the electrochemical reaction, the hydrogen reacts with the oxygen of the air to form water.

In order to supply the membrane electrode assembly with the reactant gases in its active operation, bipolar plates are provided. For the fluid mechanical sealing of the fuel cell and especially the bipolar plates, metallic beads in conjunction with an elastomer layer are generally used. This means that the essential functions of a seal, i.e., the elasticity and the roughness compensation, are separate from each other and assigned to the suitable material for this. The roughness compensation is assigned entirely to the elastomer layer, while the essential elastic component of the seal is provided by the metallic bead.

In order to establish a uniform pressing characteristic along the sealing line of the bipolar plate, the bead has varying geometries along the plane of the bipolar plate. The fabrication process required for the geometrical variation means that the bead roof is not level, but instead is deformed in the forming process. This means that dents and bulges are produced on the bead roof, so that the bead is uneven in a single-digit micrometer range. Elastomer layers with a thickness less than 50 μm are usually employed and they cannot adequately balance out and/or seal off this unevenness. In order to furnish an adequate seal, the height of the seal, the height of the flow field, i.e., the bipolar plate, and the gas diffusion layer situated between the bipolar plate and the membrane electrode assembly must match up. Consequently, a seal must have a height of typically 0.2 mm to 0.7 mm, preferably 0.3 mm to 0.6 mm.

In the conventional manufacturing process for a fuel cell, especially for the sealing system of the fuel cell, the metallic bead with the elastomer layer is produced in a discrete manufacturing step, for example. The prefabricated bipolar plate is supplied to this step. The depositing of the elastomer can occur, for example, in a screen printing process or in an injection molding process. The material selection for these processes is very limited on account of the workability and the adhesion. Although these requirements can be met with the chemically very stable, yet costly, fluorinated rubbers, the necessary Shore hardness needs to be established by a foaming of these materials. The result is long drying and cross-linking time. Furthermore, screen printing processes are highly prone to faults, which means a large expense for quality assurance, especially a necessary testing for leakage.

DE 10 2011 105 072 B3 discloses a method for producing a membrane electrode unit for a fuel cell, wherein thin sealing elements are arranged on a frame of the membrane electrode unit. The material described here for the sealing elements is not suited to ensuring a roughness compensation for the bipolar plate under the typical pressure forces for fuel cells, and therefore is not suited for achieving an adequate fluid mechanical sealing.

DE 10 2018 217 291 A1 describes a method for the sealing of a fuel cell, in which a sealing film is applied to at least one sealing site of the fuel cell.

DE 10 2012 221 730 A1 discloses a method for sealing off a coolant space of a bipolar plate of a fuel cell. The membrane electrode unit here is provided with sealing elements on both sides.

### BRIEF SUMMARY

Some embodiments provide a fuel cell and some embodiments provide a method for producing a fuel cell which reduce the aforementioned disadvantages.

Some embodiments of the invention relate to a fuel cell having a membrane electrode assembly installed in a cutout of a frame, on the first side of which is arranged a first bipolar plate and on its second side, opposite the first side, there is arranged a second bipolar plate.

The fuel cell is characterized in particular in that an edge region of the frame comprises a first elastomer layer, formed as a film, on its side facing toward the first bipolar plate, the edge region of the frame comprises a second elastomer layer, formed as a film, on its second side facing toward the second elastomer layer, and the elastomer layers arranged on the frame are adapted to sealing off the bipolar plates fluid mechanically by way of roughness compensation and the provided elasticity. In this way, a fuel cell is created which is more easily and thus advantageously manufactured and has a good sealing. Moreover, a larger selection of suitable materials is available for the elastomer layers.

The material for the elastomer layers may be chosen from the group of acrylate rubber (ACM), acrylonitrile-butadiene rubber (NBA), ethylene-propylene-diene (monomer) rubber (EPDM), fluorinated rubber (FPM, XFPM), methyl/vinyl rubber (MVQ), hydrogenated acrylonitrile butadiene rubber (HNBR), fluorosilicone rubber (FVMQ), polyester-urethane rubber (AU, PUR), styrene-butadiene rubber (SBR), natural rubber (NK), isobutene-isoprene rubber (IIR), chlorosulfonated polyethylene (CSM), chloroprene rubber (CR), perfluorinated rubber (FFPM), tetrafluorethylene/propylene rubbers (FEPM), or polytetrafluorethylene (PTFE). Furthermore, it is the elastomer layers may have a Shore hardness less than 30° A. In order to achieve the required Shore hardness, the elastomer layers may be formed from foamed elastomer material. Furthermore, the thickness of the elastomer layers on each side may be at most 50 μm and in the pressed state is less than 30 μm.

The first elastomer layer and the second elastomer layer may form a film composite. The film composite may consequently be a multilayered film composite.

In order to save on material, the first elastomer layer and/or the second elastomer layer may cover the edge region of the frame only in certain regions.

In this context, the first elastomer layer may cover a first region on the first side of the edge region of the frame, the second elastomer layer may cover a second region on the second side of the edge region of the frame, and the covered regions may be asymmetrically formed with respect to a longitudinal axis.

Furthermore, the required sealing may occur when the first elastomer layer differs from the second elastomer layer in its thickness and/or in the material used.

Furthermore, the fuel cell may comprise a second frame having a second cutout, such that the first frame and the second frame may be stacked, and for one of the elastomer layers to be arranged as a film between the first frame and the second frame, on its edge region. One of the gas diffusion layers may be arranged in the second cutout of the second frame. The second cutout of the second frame may have a larger surface than the cutout of the first frame. The frames are may be made of a different material, in order to provide different functions for the frames within the fuel cell structure. Furthermore, the second frame may be radially offset to the outside relative to the first frame. In order to improve the sealing effect, a third elastomer layer formed as a film may be between the second frame and the bipolar plate adjoining the second frame.

The method may include the following steps:
providing a frame material formed as a first film, a first elastomer layer formed as a second film, and a second elastomer layer formed as a third film,
placing the layers on top of one another and combining them to form a frame sealing functional layer such that the first elastomer layer is arranged on a first side of the frame material and the second elastomer layer is arranged on a second side of the frame material situated opposite the first side,
cutting the frame sealing functional layer into single frame elements and removing a cutout from the frame elements,
positioning the membrane electrode assembly in the cutout of the frame element,
providing of two bipolar plates and positioning the first bipolar plate on the first side of the membrane electrode assembly and positioning the second bipolar plate on the second side of the membrane electrode assembly situated opposite the first side, and
form-fitting connection of the membrane electrode assembly to the frame element and the bipolar plates.

The features describe above and below allow a lower-cost production of the fuel cell, since a larger material selection is available due to the modified processes and adhesion requirements. Due to the robust process, a reduced quality control is also possible, so that a simplified leakage testing is adequate. The connection may be produced by way of a binding agent as a material bonded connection. A removable connection between the frame element, the membrane electrode assembly, and the bipolar plates may be achieved. This may be achieved, for example, by press fitting, i.e., by exerting a pressure perpendicular to the bipolar plate.

The expanded material selection encompasses materials such as acrylate rubber (ACM), acrylonitrile-butadiene rubber (NBA), ethylene-propylene-diene (monomer) rubber (EPDM), fluorinated rubber (FPM, XFPM), methyl/vinyl rubber (MVQ), hydrogenated acrylonitrile butadiene rubber (HNBR), fluorosilicone rubber (FVMQ), polyester-urethane rubber (AU, PUR), styrene-butadiene rubber (SBR), natural rubber (NK), isobutene-isoprene rubber (IIR), chlorosulfonated polyethylene (CSM), chloroprene rubber (CR), perfluorinated rubber (FFPM), tetrafluorethylene/propylene rubbers (FEPM), or polytetrafluorethylene (PTFE). In order to obtain a Shore hardness at less than 30° A, the method may additionally include a foaming of the elastomer material.

The reactant gases may be distributed on the active region of the membrane electrode assembly when two gas diffusion layers are arranged on both sides between the frame sealing functional layer and the bipolar plates and connected to them by form fitting and material bonding.

The step of combining the layers to form a frame sealing functional layer may be done by way of spraying, casting, calendaring, or transferring in order to generate the frame sealing functional layer.

Furthermore, the first elastomer layer and/or the second elastomer layer may adhere by way of film transfer to the frame material only in certain regions, such that the frame sealing functional layer comprises the first elastomer layer and/or the second elastomer layer only in certain regions.

In this context, the region of the first elastomer layer and the region of the second elastomer layer may be deposited asymmetrically with respect to a longitudinal axis of the membrane electrode assembly. In this context, the first elastomer layer and the second elastomer layer may have a different thickness and/or comprise a different material composition and/or a different material.

In order to further simplify the process, the frame material, the first elastomer layer and the second elastomer layer may each be provided wound up on a roll. Due to the roll-based fabrication, a reduced investment may be required for the production of the fuel cell. Furthermore, a benefit of a roll process is that the applying of the layers takes place faster than in the case of screen printing. The adapting of the adhesion of the elastomer layers to the frame material may be easier and the drying and cross-linking times may be organized more easily.

The features and combinations of features mentioned above in the description and the features and combinations of features mentioned below in the description of the figures and/or shown solely in the figures can be used not only in the particular indicated combination, but also in other combinations or standing alone. Thus, embodiments which are not shown explicitly or explained in the figures, yet which can be created and emerge from separated combinations of features from the explained embodiments should be viewed as also being disclosed and encompassed herein.

### BRIEF DESCRIPTION OF THE SEVERAL VIEWS OF THE DRAWINGS

Further benefits, features and details will emerge from the claims, the following description of embodiments, and the drawings.

FIG. 1 shows a schematic representation of a fuel cell having two elastomer layers.

FIG. 2 shows a schematic representation of the framed membrane electrode assembly with a frame sealing functional layer.

FIG. 3 shows a further schematic representation of a framed membrane electrode assembly with a frame sealing functional layer.

FIG. 4 shows a further schematic representation of a framed membrane electrode assembly with a frame sealing functional layer.

FIG. 5 shows a schematic representation of a further fuel cell having three elastomer layers and two frames.

### DETAILED DESCRIPTION

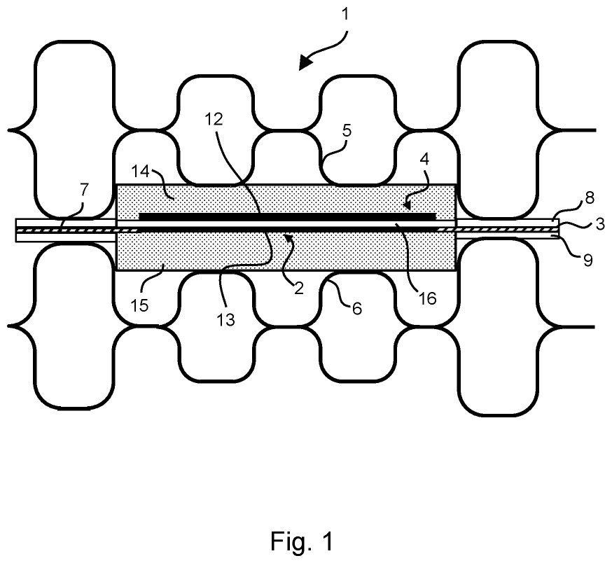

FIG. 1 shows a fuel cell having a membrane electrode assembly 4 installed in a cutout 2 of a frame 3. On a first side of the membrane electrode assembly 4, there is arranged a first bipolar plate 5 and on a second side, situated opposite the first side, there is arranged a second bipolar plate 6. The membrane electrode assembly 4 comprises a proton conducting membrane 16, on the first side of which there is arranged an anode 12, and on its second side, situated opposite the first side, there is arranged a cathode 13. The anode 12 and the cathode 13 may comprise a catalyst layer formed from a precious metal or blends comprising precious metals such as platinum, palladium, ruthenium or the like, which serve as reaction accelerators for the reaction of the fuel cell.

In such a polymer electrolyte membrane fuel cell (PEM fuel cell), fuel or fuel molecules, such as hydrogen, are split up into protons and electrons at the anode 12. The membrane 16 lets through the protons (such as H⁺), but is impenetrable to the electrons (e⁻⁾. The membrane 16 is formed from an ionomer, such as a sulfonated tetrafluorethylene polymer (PTFE) or a polymer of perfluorinated sulfonic acid (PFSA). At the anode 12, the following reaction occurs: 2H₂→4H⁺+4e⁻ (oxidation/electron surrender).

While the protons pass through the membrane 16 to the cathode 13, the electrons are taken by an external circuit to the cathode 13 or to an energy accumulator. A cathode gas, especially oxygen or air containing oxygen, is provided at the cathode 13, and the following reaction occurs: O₂+4H⁺+4e⁻→2H₂O (reduction/electron uptake).

The two electrodes, namely, the anode 12 and the cathode 13, are each associated with a gas diffusion layer 14, 15. The gas diffusion layers 14, 15 may be formed from carbon fiber paper (CFP). Other suitable fibrous and/or nonwoven layers may likewise serve as a gas diffusion layer and as the basis for a gas diffusion electrode.

In order to improve the flow of fluid or gas within the fuel cell 1 and to increase the water content in the membrane 16, the gas diffusion layers 14, 15 may be provided with a microporous layer (not shown). The lateral dimensions of the microporous layer may correspond to the lateral dimensions of the respective gas diffusion layer 14, 15.

An edge region 7 of the frame 3 comprises a first elastomer layer 8 formed as a film on its side facing toward the first bipolar plate 5, while the edge region 7 of the frame 3 comprises a second elastomer layer 9 formed as a film on its second side facing toward the second bipolar plate 6. The elastomer layers 8, 9 arranged on the frame 3 are adapted to fluidly seal the bipolar plates 5, 6 due to roughness compensation and the provided elasticity. The frame 3, the first elastomer layer 8 and the second elastomer layer 9 may form a film composite. This construction allows a sealing of the bipolar plates 5, 6, wherein the elastomer layers 8, 9 have the function of both the roughness compensation and the provided elasticity. Alternatively, the elastomer layers 8, 9 may be present initially as a fluid mass, such as a varnish or a paste, and be pressed onto or cast onto the frame 3 formed as a film.

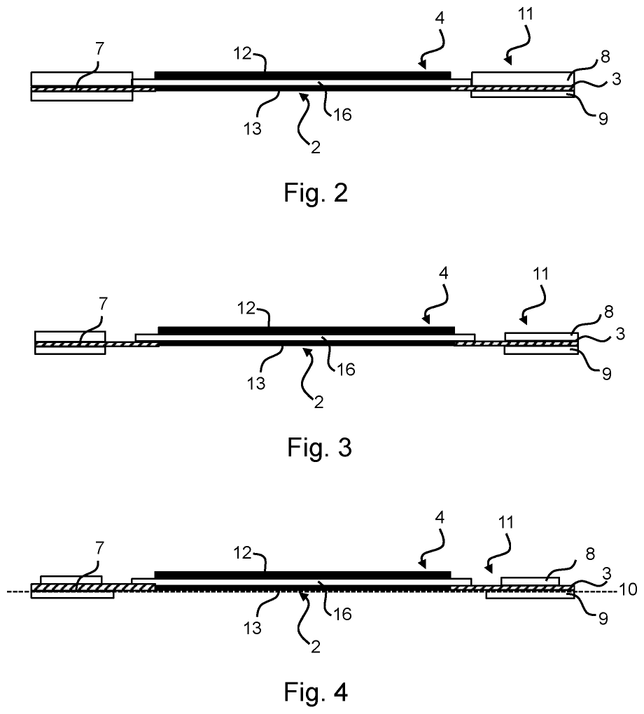

FIG. 2 shows the framed membrane electrode assembly 4 having a frame sealing functional layer 11. The frame sealing functional layer 11 may be the film composite formed from the frame material, i.e., the frame 3, and the first elastomer layer 8 as well as the second elastomer layer 9. In FIG. 2, by contrast with the other framed membrane electrode assemblies having a frame sealing functional layer 11, the first elastomer layer 8 is thicker than the second elastomer layer 9.

With the aid of the example in FIG. 3, it can be seen that the first elastomer layer 8 and/or the second elastomer layer 9 may cover the edge region 7 of the frame 3 only for a portion.

FIG. 4 shows a further example in which the first elastomer layer 8 covers a first portion on the first side of the edge region 7 of the frame 3, while the second elastomer layer 9 covers a second portion on the second side of the edge region 7 of the frame 3, the covered portions being asymmetrical with respect to a longitudinal axis 10.

Furthermore, the first elastomer layer 8 may differ from the second elastomer layer 9 in its material and/or in its material composition.

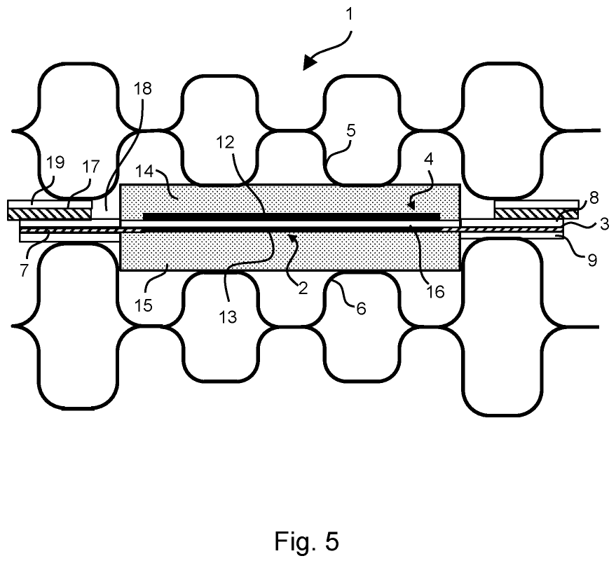

FIG. 5 shows another fuel cell, which by contrast with the fuel cell of FIG. 1, comprises a second frame 17 having a second cutout 18, in which the first gas diffusion layer 14 is received. Between the edge region of the second frame 17 and the first bipolar plate 5, there is a third elastomer layer 19 formed as a film.

The method for producing a fuel cell 1 includes the following steps: providing a frame material formed as a first film, a first elastomer layer 8 formed as a second film, and a second elastomer layer 9 formed as a third film. The films are each time rolled up onto a roll, such that a roll-based process is possible.

The individual layers, i.e., the individual films, are laid one on top of the other and combined to form a frame sealing functional layer 11 in such a way that the first elastomer layer 8 is arranged on a first side of the frame material, i.e., the frame 3, and the second elastomer layer 9 is arranged on a second side of the frame material, situated opposite the first side. The depositing and combining of the layers can be done by calendaring, spraying, casting, pressing, or transferring.

In the fuel cell 1 of FIG. 5, a further film is present as a second frame material for the second frame 17 and a third elastomer layer 19 formed as a film is provided. The individual layers, i.e., the individual films, are placed one on top of the other and combined to form a frame sealing functional layer 11 such that the first elastomer layer 8 is arranged on a first side of the frame material, i.e., the frame 3, the second elastomer layer 9 is arranged on a second side of the frame material, situated opposite the first side, the second frame material is arranged on the side of the first elastomer layer 8 facing away from the membrane electrode assembly 4, and the third elastomer layer 19 is arranged on the side of the second frame material facing away from the first elastomer layer 8. The depositing and combining of the layers may be done by calendaring, spraying, casting, pressing, or transferring.

The frame sealing functional layer 11 is cut to form single frame elements and a cutout 2 is removed from the frame elements. The cutouts 2 may be removed prior to cutting the frame elements. The membrane electrode assembly 4 is positioned in the cutout 2 of the frame element and at least two bipolar plates 5, 6 may be included. The first bipolar plate 5 is positioned on the first side of the membrane electrode assembly 4 and the second bipolar plate 6 is positioned on the second side of the membrane electrode assembly 4 situated opposite the first side. A gas diffusion layer 14, 15 is arranged between the membrane electrode assembly 4 and each of the bipolar plates 5, 6. Finally, the membrane electrode assembly 4 with the frame element, the bipolar plates 5, 6, and the gas diffusion layers 14, 15 are connected by form fitting. The connection may be made by material bonding, i.e., by way of a binding agent. Alternatively, the connection may be achieved by mechanical pressure orthogonally to the bipolar plate 5, 6, such that a removable connection is achieved between the bipolar plates 5, 6 and the frame element comprising the elastomer layers 8, 9. Furthermore, the frame element, the composition of the bipolar plates 5, 6, and/or the gas diffusion layers 14, 15 may be treated with heat, i.e., with a temperature higher than the melting temperature of the elastomer, such that the elastomer layers 8, 9 become fluid and penetrate into the relief depth of the bipolar plates 5, 6. Such penetration improves the sealing of the fuel cell 1.

In order to apply the elastomer layers 8, 9 on the frame material for only a portion, the first elastomer layer 8 and/or the second elastomer layer 9 is applied by way of film transfers on the frame material for only a portion and will adhere thereto.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A fuel cell comprising:
a frame having a cutout;
a membrane electrode assembly installed in the cutout of the frame;
a first bipolar plate arranged on a first side of the membrane electrode assembly; and
a second bipolar plate arranged on a second side of the membrane electrode assembly, the second side of the membrane electrode assembly being opposite the first side of the membrane electrode assembly,
wherein an edge region of the frame is configured as a first film,
wherein a first elastomer layer is configured as a second film and is provided on a first side of the edge region of the frame, the first side of the edge region of the frame facing toward the first bipolar plate,
wherein a second elastomer layer is configured as a third film and is provided on a second side of the edge region of the frame, the second side of the edge region of the frame facing toward the second bipolar plate,
wherein the edge region of the frame, the first elastomer layer, and the second elastomer layer form a composite film, and
wherein the first and second elastomer layers are configured to fluidly seal the bipolar plates via roughness compensation and provided elasticity.

2. (canceled)

3. The fuel cell according to claim 1, wherein at least one of the first elastomer layer and the second elastomer layer only partially cover the edge region of the frame.

4. The fuel cell according to claim 1, wherein the first elastomer layer covers a first region on the first side of the edge region of the frame, the second elastomer layer covers a second region on the second side of the edge region of the frame, and the first region and the second region are asymmetrical with respect to a longitudinal axis.

5. The fuel cell according to claim 1, wherein a thickness of the first elastomer layer differs from a thickness of the second elastomer layer and/or a material of the first elastomer layer differs from a material of the second elastomer layer.

6. A method for producing a fuel cell, the method comprising:
placing a first elastomer layer on a first side of a frame material and a second elastomer layer on a second side of the frame material, the second side of the frame material being situated opposite the first side of the frame material, the frame material forming a first film, the first elastomer layer forming a second film, and the second elastomer layer forming a third film;
combining the first elastomer layer and the second elastomer layer with the frame material to form a frame sealing functional layer;
cutting the frame sealing functional layer into single frame elements;
removing a cutout from the single frame elements;
positioning a membrane electrode assembly in the cutout of the single frame element;
positioning a first bipolar plate on a first side of the membrane electrode assembly and positioning a second bipolar plate on a second side of the membrane electrode assembly, the second side of the membrane electrode assembly being situated opposite the first side of the membrane electrode assembly;
form-fitting the membrane electrode assembly to the single frame element and the first and second bipolar plates.

7. The method according to claim 6, wherein the first elastomer layer and the second elastomer layer are combined with the frame material by at least one of pressing, spraying, casting, calendaring, and transferring.

8. The method according to claim 6, wherein at least one of the first elastomer layer and the second elastomer layer adhere to the frame material only in portions of the frame material, such that the frame sealing functional layer comprises the first elastomer layer and/or the second elastomer layer only adjacent to portions of the frame material.

9. The method according to claim 6, wherein a thickness of the first elastomer layer differs from a thickness of the second elastomer layer and/or a material of the first elastomer layer differs from a material of the second elastomer layer.

10. The method according to one claim 6, wherein the frame material, the first elastomer layer, and the second elastomer layer each provided wound on a roll.
